(19) United States
(12) Patent Application Publication
(10) Pub. No.: US 2013/0100162 A1
(43) Pub. Date: Apr. 25, 2013

(54) METHOD, PROGRAM AND DEVICE FOR DISPLAYING SCREEN IMAGE

(71) Applicant: FURUNO ELECTRIC CO., LTD., Nishinomiya (JP)

(72) Inventor: Kensuke Iseri, Akashi-shi (JP)

(73) Assignee: FURUNO ELECTRIC CO., LTD., Nishinomiya (JP)

(21) Appl. No.: 13/656,261

(22) Filed: Oct. 19, 2012

(30) Foreign Application Priority Data
Oct. 21, 2011 (JP) 2011-231878

(51) Int. Cl. G09G 5/00

(52) U.S. Cl. 345/629; 345/660

(57) ABSTRACT

An image display device is provided. The device includes a main displaying module for displaying an image, a selected area displaying module for specifically displaying a selected area that is at least a part of the image displayed by the main displaying module, an image acquiring module for acquiring an image corresponding to the selected area, a zoom processing module for creating image data by zooming the image acquired by the image acquiring module to correspond to a predetermined display area, a zoom displaying module for displaying the image data in the display area, and an area adjusting module for adjusting at least one of a position and a size of the selected area and a size of the display area.

### CROSS-REFERENCE TO RELATED APPLICATION(S)

The application claims priority under 35 U.S.C. §119 to Japanese Patent Application No. 2011-231878, which was filed on Oct. 21, 2011, the entire disclosure of which is hereby incorporated by reference.

1. Technical Field

The present invention generally relates to an image display device for zooming in and out an image displayed on a display screen.

2. Background of the Invention

Conventionally, radar apparatuses and ECDIS (Electronic Chart Display and Information System) which are installed in ships have a function of zoom-in displaying a part of a radar image or a chart (nautical chart). Although various kinds can be considered as a method of achieving such a function of zooming in a part of the image, it is desired that a user can instinctively specify an area which he/she wants to zoom in, and easily and finely adjust a zoom-in magnification, for example.

JP3278329B discloses a multi-window display device that while an entire image is displayed in a window, creates a new window where an area specified by a pointing device, such as a mouse, is displayed. In JP3278329B, the newly created window can be changed its size and/or a display magnification, similarly to other normal windows. With this configuration in JP3278329B, simply through an easy and instinctive operation of specifying an arbitrary area desired by a user, a new window displaying the similar contents as in the specified area can promptly and smoothly be opened, and through a desired zooming operation, display contents in the new window at a magnification instinctively optimal to the user can be obtained while being visually checked by the user.

With the configuration in JP3278329B, the display magnification is selected from a “zoom” menu after the area is specified and the new window is created. Thus, with the configuration in JP3278329B, even if a certain area is to be displayed in zoom mode, the zoom-in display will not be performed by only specifying the area, and two-stage operations including creating the new window and then selecting the display magnification are required. Therefore, it can be considered that the configuration in JP3278329B is complicated as a method of displaying an arbitrary area in zoom mode, and there is a scope for improvement.

Further, the configuration in JP3278329B also has a problem that an area to be zoomed cannot instinctively be specified. For example, if a user wants to display a certain area at a twice magnification. In this case, the user first creates a new window for the specified area, and then changes the display magnification of the new window to twice. However, when the display magnification of the new window is changed to twice, the original display contents in the new window is zoomed in at a fourth times magnification with respect to an area ratio, and thus, only one-fourth of the area of the originally specified area is displayed in the window, and the rest of three-fourth of the area is not displayed. Therefore, even if the user specifies the area with the intention of zooming in from the start, when it is actually displayed in the zoom-in mode, most of the specified area is not displayed. Thus, with the configuration in JP3278329B, a user cannot instinctively specify the area to be zoomed in in the first place.

Further, the configuration in JP3278329B has a problem that once an area is specified and a new window is created, the specified area cannot be adjusted. For example, when an undesired area is specified by mistake, the operation of specifying the area needs to be performed from the start again, and another new window is required to be created. Therefore, the work of specifying the area cannot be performed smoothly with the configuration in JP3278329B.

### SUMMARY OF THE INVENTION

The present invention is made in view of the above situation, and generally aims to provide a display device in which a user can instinctively and easily perform an operation of displaying a desired area in zoom mode.

According to an aspect of the invention, an image display device is provided. The device includes a main displaying module for displaying an image, a selected area displaying module for specifically displaying a selected area that is at least a part of the image displayed by the main displaying module, an image acquiring module for acquiring an image corresponding to the selected area, a zoom processing module for creating image data by zooming the image acquired by the image acquiring module to correspond to a predetermined display area, a zoom displaying module for displaying the image data in the display area, and an area adjusting module for adjusting at least one of a position and a size of the selected area and a size of the display area.

In this manner, the part of the image displayed by the main displaying module can be selected, zoomed, and then displayed. The position and the size of the selected area or the display area can be adjusted later, and thus, a magnification in zooming and the like can be adjusted finely later. Moreover, by specifically displaying the selected area in the image, the user can instinctively grasp which area he/she is selecting. Therefore, the user can instinctively adjust the position of the selected area, the magnification in zooming, or the like.

The area adjusting module may be a pointing device to be operated by a user, and adjust at least one of the position and the size of the selected area through dragging the specifically displayed selected area.

As above, the displayed selected area can be adjusted by dragging the area. Thus, the selected area can be adjusted instinctively.

The device may also include a deleting module for deleting at least one of the images processed by the selected area displaying module and the zoom displaying module.

In this manner, when the zoom display is not necessary anymore, the specific display or the displayed area can be deleted.

The main displaying module may selectively display one or more of a plurality of layer images superimposed on each other. The image acquiring module may acquire a different layer image from the one or more layer images displayed by the main displaying module.

As above, the images to be displayed by the main displaying module and the zoom displaying module are configured by the multiple layers. Thus, necessary information can be displayed while being superimposed on each other. Moreover, the image acquiring module can acquire the different image from the layer image displayed by the main displaying module. Thus, a layer image different from the image of the main displaying module can be displayed by the zoom displaying module. Therefore, the user can select an appropriate display mode as needed.

The device may also include a layer storing module for storing the one or more layer images, the one or more layer images being written with at least one of a nautical chart, a radar image, and information on another ship acquired by an automatic identification system (AIS). The image display device may be equipped in a ship.

According to this configuration, the radar image and/or the other ship information can be displayed while being superimposed on the image of the nautical chart. Moreover, according to the configuration in the above aspect, because the layer image displayed by the main displaying module can be different from that displayed by the zoom displaying module, information necessary in traveling a ship can be displayed according to the will of the user.

When the image displayed by the main displaying module is scrolled, rotated, or changed in its scale, the position of the selected area may move to follow the image.

In this manner, when the image displayed by the main displaying module is scrolled or the like, the selected area moves along with the image. Therefore, even when the image displayed by the main displaying module is scrolled or the like, the same area of the image can be kept displayed by the zoom displaying module.

The selected area may be moved to follow the image displayed by the main displaying module with reference to central coordinates of the selected area.

In this manner, even when the image displayed by the main displaying module is turned or changed in it scale, the position of the selected area does not vary.

The selected area and the display area may be shaped in rectangles. When the size of the selected area or the display area is changed, a horizontal-to-vertical ratio of the area may be fixed.

Thus, although the horizontal-to-vertical ratio of the area is difficult to be fixed if the size of the area is freely changeable, by allowing the horizontal-to-vertical ratio to be fixed as described above, the size of the area can be adjusted finely while keeping the horizontal-to-vertical ratio.

The selected area and the display area may be shaped in circles.

Thus, by shaping the areas in circles, the size of the selected area or the display area can be changed based on a single parameter of radius (or diameter), resulting that the fine adjustment by the user can be performed easier.

The device may also include an image processing module for performing predetermined image processing on the image acquired by the image acquiring module. The zoom displaying module may display the processed image in the display area.

As above, the processed image is displayed in the display area. Thus, the processed image can be easily compared to the image that is not processed (image displayed by the main displaying module).

According to another aspect of the invention, computer readable media configured to store in a non-transitory manner a computer executable program, which upon execution by a processor of a computer causing the computer to display an image is provided. The media includes causing a computer to display the image, causing a computer to specifically display a selected area that is at least a part of the displayed image, causing a computer to acquire the image corresponding to the selected area, causing a computer to create image data by zooming an image corresponding to the selected area to correspond to a predetermined display area, causing a computer to display the image data in the display area, and causing a computer to adjust at least one of a position and a size of the selected area and a size of the display area.

In this manner, the part of the image can be selected, zoomed, and then displayed. The position and the size of the selected area or the display area can be adjusted later, and thus, a magnification in zooming and the like can be adjusted finely later. Moreover, by specifically displaying the selected area in the image, the user can instinctively grasp which area he/she is selecting. Therefore, the user can instinctively adjust the position of the selected area, the magnification in zooming, or the like.

According to further another aspect of the invention, a method of displaying an image is provided. The method includes displaying the image, specifically displaying a selected area that is at least a part of the displayed image, acquiring the image corresponding to the selected area, creating image data by zooming an image corresponding to the selected area to correspond to a predetermined display area, displaying the image data in the display area, and adjusting at least one of a position and a size of the selected area and a size of the display area.

In this manner, the part of the image can be selected, zoomed, and then displayed. The position and the size of the selected area or the display area can be adjusted later, and thus, a magnification in zooming and the like can be adjusted finely later. Moreover, by specifically displaying the selected area in the image, the user can instinctively grasp which area he/she is selecting. Therefore, the user can instinctively adjust the position of the selected area, the magnification in zooming, or the like.

### BRIEF DESCRIPTION OF THE DRAWINGS

The present disclosure is illustrated by way of example and not by way of limitation in the figures of the accompanying drawings, in which the like reference numeral indicate like elements and in which:

FIG. 1 is a block diagram showing a configuration of an image processing device according to an embodiment of the present invention;

FIG. 2 is a view showing an example of an image displayed in a main display area;

FIG. 3 is a view conceptually showing a plurality of layer images stored by a layer storing module;

FIG. 4 is a view showing how an area selecting window and a zoom display window are displayed;

FIG. 5 is view conceptually showing processing of extracting a selected area and displaying it in zoom mode;

FIG. 6 is a view showing how a size of the window is adjusted and a display magnification thereof is changed from the state in FIG. 4;

FIG. 7 is a view showing how another window overlaps with the window of the selected area; and

FIG. 8 is a flowchart of an image displaying method.

### DETAILED DESCRIPTION

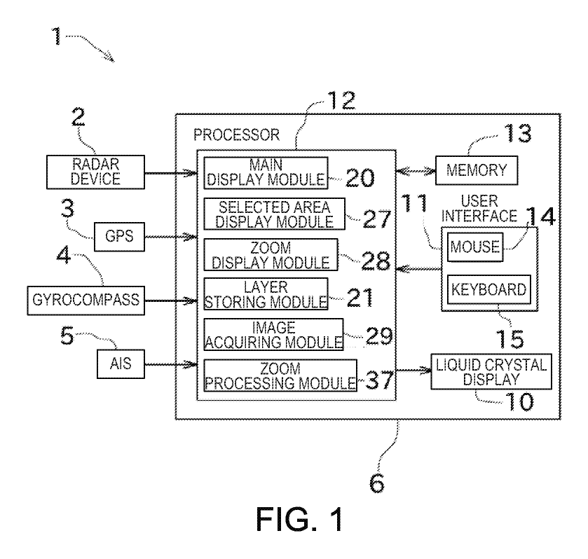

Next, an embodiment of the present invention is described with reference to the appended drawings. FIG. 1 shows a block diagram of an information display system 1 equipped with an image display device 6 according to this embodiment.

The information display system 1 is an electronic chart display and information system (ECDIS) installed in a ship, and displays various information required in navigation. The ship information display system 1 includes a radar device 2, a GPS (Global Positioning System) receiver 3, a gyrocompass 4, an AIS (Automatic Identification System) transceiver 5, and an image display device 6.

The radar device 2 has a well-known configuration of acquiring a state of an object around the ship through transceiving radio waves by an antenna, and creating a two-dimensional image (radar image) showing the state of the object around the ship. The radar image created by the radar device 2 is outputted to the image display device 6. The GPS receiver 3 has a known configuration of acquiring terrestrial absolute coordinates of the ship based on signals from GPS satellites. The absolute coordinates acquired by the GPS receiver 3 is outputted to the image display device 6. The gyrocompass 4 acquires a heading of the ship. The heading acquired by the gyrocompass 4 is outputted to the image display device 6. The AIS transceiver 5 has a known configuration of wirelessly transmitting therearound AIS information, such as a current position, a speed, and the heading of the ship, and receiving AIS information from other ship(s). The AIS information received by the AIS transceiver 5 is outputted to the image display device 6.

The image display device 6 includes a liquid crystal display 10 where a color display is available, a user interface 11, a processor 12, and a memory 13.

The user interface 11 is configured with an input device which a user can operate, such as a mouse 14 (pointing device) or a keyboard 15. The processor 12 is configured as a computer including a CPU or other processor, volatile memory such as random access memory (RAM) and non-volatile memory such as Read Only Memory (ROM). The memory 13 is a hard disk or the like and is stored with software, such as a program executed by the processor 12. Moreover, the memory 13 is stored with data, such as a chart of a marine area in the vicinity (electronic navigational chart). The image display device 6 executes an image display program stored in the memory 13 through the processor 12 so as to display various image information including the chart, the radar image, and the AIS information of other ship(s), on the liquid crystal display 10.

The image display device 6 is configured with a multi-window system in which standard GUI (graphical user interface) components (e.g., window, button, and pull-down menu) can be used. The program executed by the processor 12 enables a graphical screen display on the liquid crystal display 10 by using this window system. Moreover, this window system is configured to be able to operate the GUI through a known click operation or a drag operation by the mouse 14, for example.

Next, the image display program that is one of programs executable by the image display device 6 is described. This image display program is for displaying the chart, the radar image, the AIS information of other ship(s) and the like on the liquid crystal display 10.

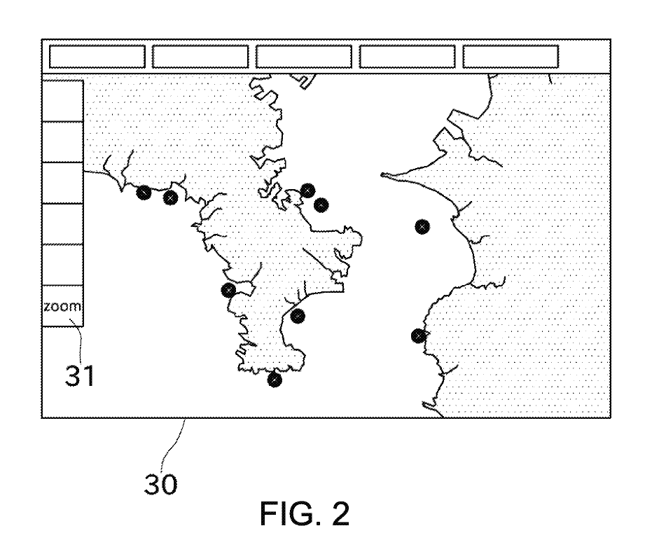

Due to the start of the image display program, a display area (main display area 30) is secured in the liquid crystal display 10 where the image is displayed by the image display program. The image display program is configured to achieve a main display function of displaying the image in the main display area 30, through the processor 12. Therefore, it can also be said that the processor 12 is a main display module 20. The contents displayed in the main display area 30 by the main display module 20 are illustrated in FIG. 2.

As shown in FIG. 2, in the main display area 30 of the image display program, the images of the various GUI components for the user to operate are superimposed on the image of the chart (electronic navigational chart) and displayed. Moreover, although it is not illustrated, in the image display program of this embodiment, the radar image and/or an AIS symbol can be displayed while being superimposed on the image of the chart. To achieve the superimposed display, the image display program manages the images to be displayed in the main display area 30 in a multi-layer structure. A memory range where a plurality of layer images can be stored is secured in the processor 12. Therefore, it can also be said that the processor 12 is a layer storing module 21.

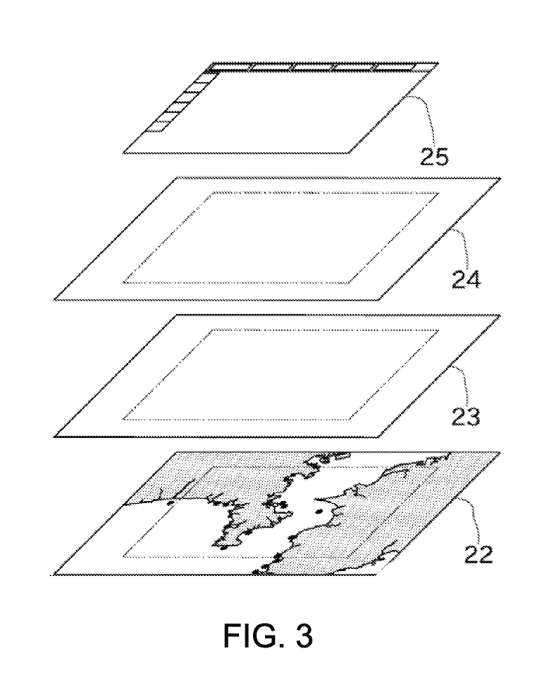

FIG. 3 conceptually shows layer images stored in the layer storing module 21. The layer storing module 21 of this embodiment stores four layer images of as a chart layer 22, a radar layer 23, an AIS layer 24, and a GUI layer 25. Each layer image is a two-dimensional bitmap image.

The image of the chart (electronic navigational chart) is written into the chart layer 22. Note that, the data of the chart stored in the memory 13 is a vector image. The processor 12 creates a chart image in a bitmap form through rasterizing an area of the vector formed data of the chart that is to be displayed in the main display area 30. The generated chart image is written into the chart layer 22 stored in the layer storing module 21.

The radar image obtained from the radar device 2 is written into the radar layer 23. Further, an AIS image and the like in which based on the current position of the other ship acquired by the AIS transceiver 5, an AIS symbol indicating a position of other ship around the ship is plotted is written into the AIS layer 24 (note that, the contents of the radar layer 23 and the AIS layer 24 are not illustrated). Moreover, images of GUI for the user to operate through the image display program are written into the GUI layer 25.

The main display module 20 reads out each layer image from the layer storing module 21, superimposes the layer images on each other to create a single image, and then displays it in the main display area 30. When the layer images are superimposed, the GUI layer 25 is positioned at the top. Thus, the GUI for the user to operate can always be displayed on the top, and the GUI will never be hidden by any image, such as the chart.

Moreover, according to the above configuration, the radar image and the AIS symbol and the like can be displayed while being superimposed on the chart image. In this manner, a radar echo corresponding to a land or a construction can easily be distinguished by displaying the radar image being superimposed on the chart image, for example. Moreover, the current position of the other ship can be confirmed on the chart by displaying the AIS symbol being superimposed on the chart image, for example.

Note that, the respective central coordinates, scales and the like of the chart layer 22, the radar layer 23, and the AIS layer 24 are matched with each other so that the layer images can appropriately be superimposed on each other.

Obviously, it is not necessary to always superimpose all the four layer images and display them in the main display area 30. In the image display program of this embodiment, the user can suitably select one or more layer images to be displayed in the main display area 30 among the four layer images. The main display module 20 displays only the layer image(s) specified by the user in the main display area 30. In this manner, it becomes possible to only display the information required by the user in the main display area 30.

Moreover, in this embodiment, the sizes of the images of the chart layer 22, the radar layer 23, and the AIS layer 24 are set to be slightly larger than the main display area 30. By preparing such images larger than the main display area 30, it supports the scroll of the image in the main display area 30, for example. The main display module 20 reads out each layer image through clipping to fit the main display area 30, then superimposes the read layer images on each other, and displays it in the main display area 30. Obviously, if the layer image is scrolled over a range of the image, the image will be interrupted. Therefore, in this case, each layer image is newly created (e.g., a chart image in the bitmap form is newly created based on the vector formed data of the chart).

Next, a characteristic configuration of the image display device 6 is described.

The image display device 6 of this embodiment can zoom the image displayed in the main display area 30. The zoom display of the image can be started by the user performing a predetermined operation through the user interface. For example, in this embodiment, the zoom display is started by the user clicking a ZOOM button 31 displayed on the display screen.

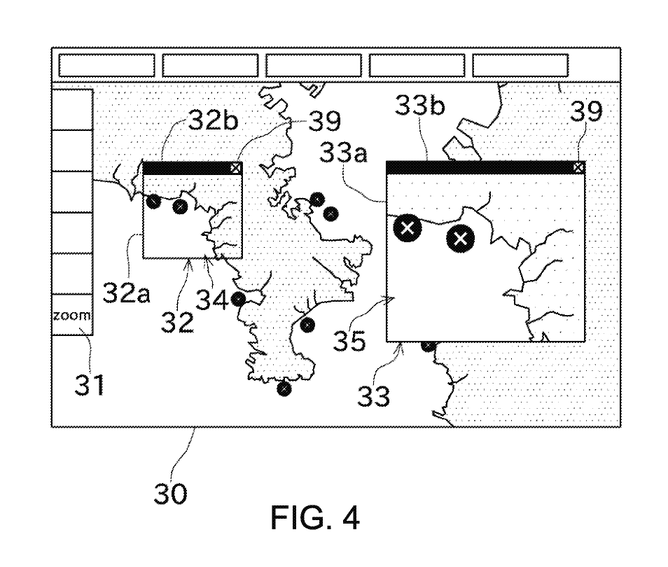

When the user clicks the ZOOM button 31 and the zoom display is started, an area selecting window 32 and a zoom display window 33 shown in FIG. 4 are displayed in the main display area 30. The image in the area selected for the area selecting window 32 is zoomed and displayed in the zoom display window 33. Hereinafter, this configuration is described in detail.

In the image display program, the processor 12 achieves a selected area displaying function of displaying the area selecting window 32 in the main display area 30. Therefore, it can also be said that the processor 12 is a selected area display module 27. When the user clicks the ZOOM button 31, the selected area display module 27 writes the area selecting window 32 into the GUI layer 25 at a predetermined position and in a predetermined size. In this manner, the area selecting window 32 can be displayed in the main display area 30.

As shown in FIG. 4, the area selecting window 32 includes a rectangular window frame 32a and a title bar 32b associated with the window frame. The selected area display module 27 changes the position and/or size of the area selecting window 32 according to the operation by the user. Thus, as the user drags the title bar 32b of the area selecting window 32 through the mouse 14, the selected area display module 27 moves the position of the area selecting window 32 according to the drag operation. Moreover, as the user drags the window frame 32a of the area selecting window 32 through the mouse 14, the selected area display module 27 changes the size of the area selecting window 32 according to the drag operation. By such an instinctive operation through the mouse 14, the user can adjust the position and size of the area selecting window.

In the GUI layer 25, the window frame 32a of the area selecting window 32 is not illustrated with anything, and a lower layer is transparent. For example, in FIG. 4, the chart image, which is one of the lower layers, is partially transparent in the window frame 32a of the area selecting window 32. In the image displayed in the main display area 30, the area surrounded by the window frame 32a is defined as “the selected area 34.” Note that, the area selecting window 32 is continuously displayed in the main display area 30 unless the user performs a specific deleting operation (described later). In a different perspective, it can be said that the selected area display module 27 indicates the range of the selected area 34 by a specific display referred to as “an enclosed display by the window frame 32a.” The user can grasp the position and size of the selected area 34 at one view based on the position and size of (the window frame 32a of) the area selecting window 32. Moreover, the position and size of the area selecting window 32 can arbitrarily be changed by the operation through the mouse 14. Therefore, the user can arbitrarily adjust the position and size of the selected area 34 through the mouse 14. In this regard, it can be said that the mouse 14 is an area adjusting module.

Moreover, in the image display program, the processor 12 achieves a zoom display function of displaying the zoom display window 33 in the main display area 30. Therefore, it can also be said that the processor 12 is a zoom display module 28. When the user clicks the ZOOM button 31, the zoom display module 28 writes the zoom display window 33 into the GUI layer 25 at a predetermined position and in a predetermined size. In this manner, the zoom display window 33 can be displayed in the main display area 30.

As shown in FIG. 4, the zoom display window 33 includes a rectangular window frame 33a and a title bar 33b associated with the window frame. The zoom display module 28 changes the position and/or size of the zoom display window 33 according to the operation by the user. Thus, as the user drags the title bar 33b of the zoom display window 33 through the mouse 14, the zoom display module 28 moves the position of the zoom display window 33 according to the drag operation. Moreover, as the user drags the window frame 33a of the zoom display window 33 through the mouse 14, the zoom display module 28 changes the size of the zoom display window 33 according to the drag operation. By such an instinctive operation through the mouse 14, the user can adjust the position and size of the zoom display window 33.

Inside the window frame 33a of the zoom display window 33 is defined as a rectangular zoom display area 35 (display area). The user can arbitrarily adjust the size of the zoom display area 35 by changing the size of the zoom display window 33 by the operation through the mouse 14. Also in this regard, it can be said that the mouse 14 is the area adjusting module.

Note that, in the image display program of this embodiment, the positions and sizes of the area selecting window 32 and the zoom display window 33 can be adjusted by various methods other than the drag operation through the mouse 14. For example, the area selecting window 32 or the zoom display window 33 can be moved or changed in its size by rotating a wheel of the mouse 14.

Moreover, in the image display program of this embodiment, the position of the area selecting window 32 can be inputted in value. The value input can have a configuration in which x-y coordinates are specified on the display screen or a configuration in which a latitude and a longitude of the chart displayed in the main display area 30 are specified. For example, a value input box where the position of the area selecting window 32 is specified in value is illustrated in the GUI layer as needed. The user inputs the latitude and longitude of the central coordinates of the area that he/she wants to select, in the value input box by operating the keyboard 15, etc. In this manner, the area selecting window 32 automatically moves to the position specified by the latitude and longitude. Thus, when the latitude and longitude of the area to be displayed in zoom mode is known in advance, the selected area can accurately be set. Obviously, the size of either the selected area 34 or the zoom display area 35 may be inputted in value.

Additionally, in the image display program of this embodiment, the position and size of the area selecting window 32 can be adjusted by the operation through the keyboard 15. For example, when an arrow key (direction key) on the keyboard 15 is pressed, the area selecting window 32 is moved by a predetermined amount in a direction corresponding to the pressed arrow key. In this manner, a fine position adjustment that is difficult to be performed by the drag operation through the mouse 14 can be performed. Moreover, it may have a configuration in which the size of the area selecting window 32 is enlarged as “a < key” on the keyboard 15 is pressed, and the size is reduced as “a > key” is pressed.

As above, because in the image display program of this embodiment, the position and size of the area selecting window 32 (the position and size of the selected area 34) can be adjusted by the keyboard 15, it can be said that the keyboard 15 is also the area adjusting module. Obviously, alternatively or additionally, it may have a configuration in which the position and size of the zoom display window 33 are adjusted by the keyboard 15.

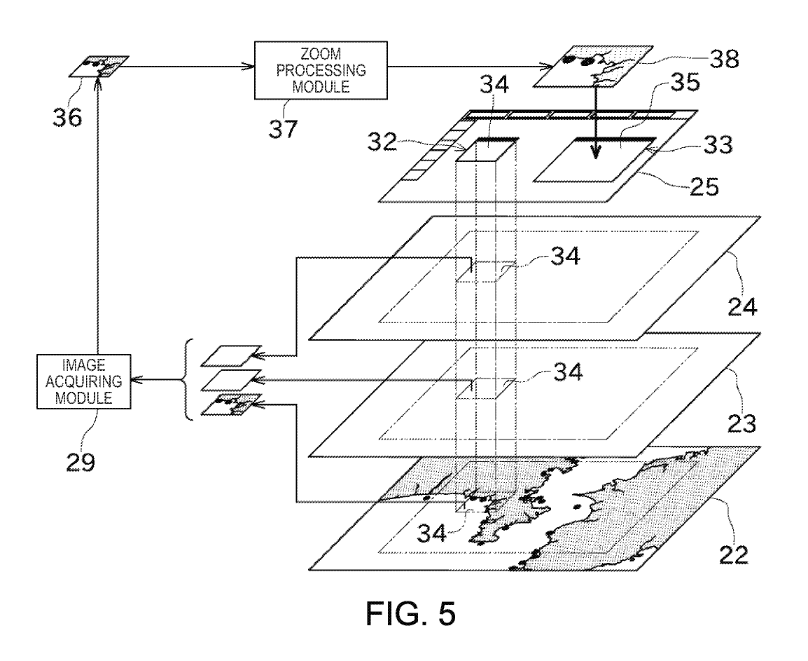

In the image display program, the processor 12 achieves an image acquiring function of copying and acquiring the image corresponding to the selected area. Therefore, it can be said that the processor 12 is also an image acquiring module 29. As conceptually shown in FIG. 5, the image acquiring module 29 reads out a rectangular area corresponding to the position and size of the selected area 34 from each layer image on the lower layer of the GUI layer and copies them. Moreover, the image acquiring module 29 superimposes the copied layer images in the rectangular area on each other and acquires a selected image 36 corresponding to the selected area.

In the image display program, the processor 12 achieves a zoom processing function of zooming the selected image 36. Therefore, it can also be said that the processor 12 is a zoom processing module 37. As shown in FIG. 5, the zoom processing module 37 creates a zoomed image 38 through zooming the selecting image 36 (image in the same size as the selected area) corresponding to the size of the zoom display area 35 of the zoom display window 33.

The zoom display module 28 writes the zoomed image 38 created by the zoom processing module 37 into the rectangular area enclosed in the window frame of the zoom display window 33 displayed in the GUI layer 25. This processing is conceptually shown in FIG. 5. In this manner, the zoomed image 38 can be displayed in the display area (zoom display area 35) of the zoom display window 33.

According to the above processing, the selected area 34 selected by the area selecting window 32 is extracted from the image displayed in the main display area 30 and it can be displayed in the zoom display window 33. The user can move the position of the area selecting window 32 while visually checking the position of the selected area 34. Therefore, the area to be displayed in the zoom display window 33 can instinctively be specified.

As described above, the image in the area selected as the selected area 34 is zoomed to correspond to the zoom display area 35. Thus, the image in the area selected by the area selecting window 32 is zoomed and can be displayed in the zoom display window 33. A display magnification of the image to be displayed in the zoom display window 33 is determined by a ratio of size between the selected area 34 and the zoom display area 35. Therefore, by adjusting the sizes of the area selecting window 32 and the zoom display window 33, the display magnification of the image to be displayed in the zoom display window 33 can arbitrarily be changed.

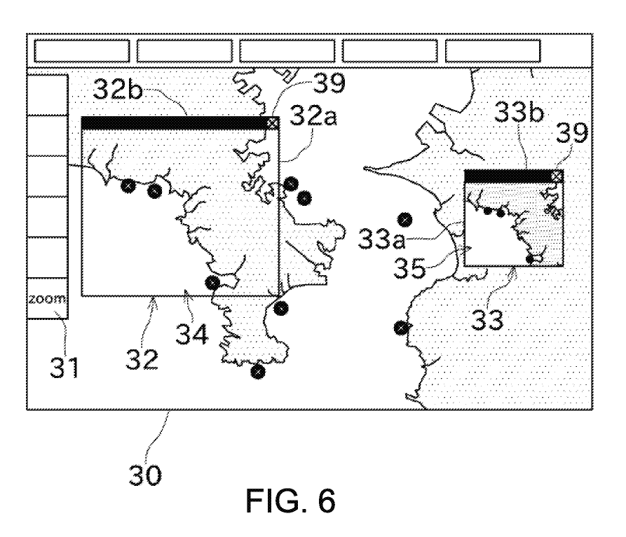

For example, in FIG. 4, the sizes of the area selecting window 32 and the zoom display window 33 are adjusted so that the zoom display area 35 becomes twice the size of the selected area 34. In this case, the display magnification of the image to be displayed in the zoom display window 33 is 2 times. Moreover, for example, in FIG. 6, the sizes of the area selecting window 32 and the zoom display window 33 are adjusted so that the zoom display area 35 becomes half the size of the selected area 34. In this case, the display magnification of the image to be displayed in the zoom display window 33 is 0.5 times.

As described above, the sizes of the area selecting window 32 and the zoom display window 33 can arbitrarily be changed. Thus, the user can arbitrarily change the display magnification of the image to be displayed in the zoom display window 33. Further, according to the configuration of this embodiment, because the image can be displayed at a desired display magnification by only adjusting the size of the area selecting window 32, the operation of “selecting the display magnification” is omitted. Moreover, the user can adjust the size of the area selecting window 32 while checking the size of the selected area 34. In this manner, the user can instinctively set which part of the image displayed in the main display area 30 is to be zoomed and displayed and the level of the zooming.

Further, in the image display program of this embodiment, one or more of the layer images to be copied by the image acquiring module 29 can be specified through the suitable operation by the user. Thus, the user can specify the layer image to be displayed in the zoom display window 33. In this manner, the information required by the user can be displayed in the zoom display window 33. The layer image to be displayed in the zoom display window 33 may be different from the layer image to be displayed in the main display area 30. If the chart layer 22, the radar layer 23, and the AIS layer 24 are displayed in the main display area 30 while superimposed on each other, it becomes possible to display only the radar layer 23 in the zoom display window 33. In this manner, if images are overlapped with another image and visually difficult to be discriminated from each other in the main display area 30, it is possible to only display a target layer image in the zoom display window 33.

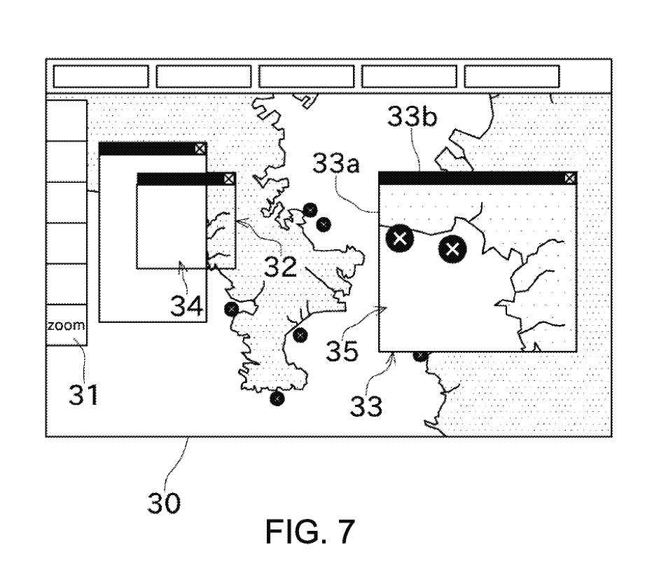

Moreover, as described above, the image acquiring module 29 copies the layer images on the lower layer of the GUI layer 25 (i.e., the image of the GUI layer 25 is not copied). Therefore, the image can be displayed in zoom mode without being interrupted by the GUI displayed in the GUI layer 25. For example, as shown in FIG. 7, even if the area desired to be displayed in zoom mode is hidden by another window, by arranging the area selecting window 32 to superimpose on the other window, the image hidden under the other window is extracted and can be displayed in the zoom display window 33.

Note that, the area selecting window 32 can also be located to protrude from the main display area 30. In this embodiment, a larger area than the main display area 30 is secured for each layer image on the lower layer of the GUI layer 25; therefore, the image acquiring module 29 can also acquire the image in the area protruding slightly from the main display area. Therefore, by setting the position of the area selecting window 32 so that the selected area 34 protrudes from the main display area 30, the image in the area that is not displayed in the main display area 30 (the area outside the main display area 30) can be displayed in the zoom display window 33.

According to the above described configuration of this embodiment, the user can instinctively and flexibly set the area desired that he/she wants to zoom. In this manner, a desired zoom display can be obtained promptly and easily. However, with this configuration, because the user can arbitrarily change the sizes of the area selecting window 32 and the zoom display window 33, it is difficult to display the image at an accurate magnification. For example, even if the user desires to “zoom in the image to exactly twice”, it is difficult to accurately adjust the size of the window frame by only the drag operation through the mouse 14.

Thus, in the image display program of this embodiment, the display magnification of the image to be displayed in the zoom display window 33 can be specified in value. For example, the pull-down menu where the display magnification can be selected from “0.5 times, “same”, “2 times” and the like is provided to the area selecting window 32 and the zoom display window 33. The user can select the desired display magnification from the pull-down menu. When the display magnification is selected, the processor 12 automatically changes the sizes of the area selecting window 32 and the zoom display window 33 so as to achieve the selected display magnification.

For example, when the user specifies the display magnification of “2 times” in the pull-down menu in the area selecting window 32, the size of the area selecting window 32 is automatically changed so that the size of the zoom display area 35 becomes twice the size of the selected area 34. Moreover, for example, when the user specifies the display magnification of “2 times” in the pull-down menu in the zoom display window 33, the size of the zoom display window 33 is automatically changed so that the size of the zoom display area 35 becomes twice the size of the selected area 34. In this manner, the sizes of the area selecting window 32 and the zoom display window 33 can be adjusted to an accurate ratio.

Further, horizontal-and-vertical sizes of the area selecting window 32 and the zoom display window 33 can arbitrarily be changed. In this manner, the horizontal to vertical ratio for the shapes of the selected area 34 and the zoom display area 35 can be set freely, and therefore, the display magnification in the horizontal direction can be different from a zoom-in ratio in the vertical direction. Thus, the image displayed in the main display area 30 can be zoomed flexibly to be displayed.

However, when the display magnification is different between the vertical and horizontal directions, an image strained in the vertical and horizontal directions is displayed in the zoom display window 33; therefore, the user may not desire this. Thus, in the image display program of this embodiment, the horizontal to vertical ratios of the selected area 34 and the zoom display area 35 can be set to be fixed. For example, a check box for specifying that the horizontal to vertical ratio is fixed is provided in the area selecting window 32 and the zoom display window 33. The user can check in the check box to fix the horizontal to vertical ratio as needed.

For example, once the user specifies to fix the horizontal to vertical ratio in the check box of the area selecting window 32, when the user changes the size of the area selecting window 32 thereafter, the horizontal to vertical ratio of the selected area 34 is kept fixed. Moreover, for example, once the user specifies to fix the horizontal to vertical ratio in the check box of the zoom display window 33, when the user changes the size of the zoom display window 33 thereafter, the horizontal to vertical ratio of the zoom display area 35 is kept fixed. In this manner, a size of a window can be changed while maintaining an arbitrary horizontal to vertical ratio.

Note that, the user can close (delete from the GUI layer 25) the area selecting window 32 and the zoom display window 33 anytime as needed. In the image display program of this embodiment, the ZOOM button 31 for starting the display of the area selecting window 32 and the zoom display window 33 functions also as an interface for deleting the area selecting window 32 and the zoom display window 33. Thus, when the user clicks the ZOOM button 31 in the state where the area selecting window 32 and the zoom display window 33 are displayed, the processor 12 deletes the area selecting window 32 and the zoom display window 33 from the GUI layer 25. Therefore, it can also be said that the processor 12 is a deleting module. In this manner, when the user does not desire the display in zoom mode, he/she can perform an instinctive operation to delete the area selecting window 32 and the zoom display window 33 promptly.

However, the method of deleting the area selecting window 32 and the zoom display window 33 is not limited to clicking the ZOOM button 31. For example, the user can click a “close” button 39 provided to the title bar of the window to delete separately the area selecting window 32 or the zoom display window 33.

Next, in the image display device 6, processing that is performed when the image displayed in the main display area 30 is scrolled, rotated, changed in its scale, or the like.

Thus, the image display device 6 of this embodiment can scroll the chart image displayed in the main display area 30 according to the current position of the ship acquired by the GPS receiver 3, rotate the image based on the heading of the ship acquired by the gyrocompass 4, and change the scale of the image according to the operation by the user.

Therefore, in the image display program of this embodiment, the selected area 34 is moved to follow the chart displayed in the main display area 30 when the chart is scrolled, rotated, changed in its scale, or the like. Specifically, the processor 12 acquires the coordinates of the central point of the selected area 34 with respect to a coordinate system (latitude and longitude) of the chart displayed in the main display area 30. When the processor 12 scrolls or the like the chart displayed in the main display area 30, it automatically changes the display position of the area selecting window 32 to maintain the coordinates of the central point of the selected area 34 in the coordinate system of the chart. Thus, when the chart displayed in the main display area 30 is scrolled, the area selecting window 32 is automatically scrolled to follow thereof.

In this manner, the selected area 34 can be fixed to absolute terrestrial coordinates (latitude and longitude). Thus, even when the chart displayed in the main display area 30 is scrolled or the like, the selected area 34 can keep selecting the same area on the surface of the earth. Therefore, even when the chart displayed in the main display area 30 is scrolled or the like, the same area can be kept displayed in the zoom display window 33. Note that, in this embodiment, because the selected area 34 follows the chart with reference to the central coordinates of the selected area 34, even when the chart is rotated or the like, the central coordinates of the selected area 34 does not shift.

Further, in the image display program of this embodiment, when the scale of the chart displayed in the main display area 30 is changed, the size of the area selecting window 32 is automatically changed according to the change of the scale. For example, when the scale of the chart displayed in the main display area 30 is changed to be twice the current scale, the processor 12 automatically changes the area selecting window 32 to be twice the size. In this manner, the area in the same range on the chart can be kept selected before and after the change of the scale. Therefore, even if the scale of the chart is changed in the main display area 30, the scale of the image displayed in the zoom display area 35 can be maintained.

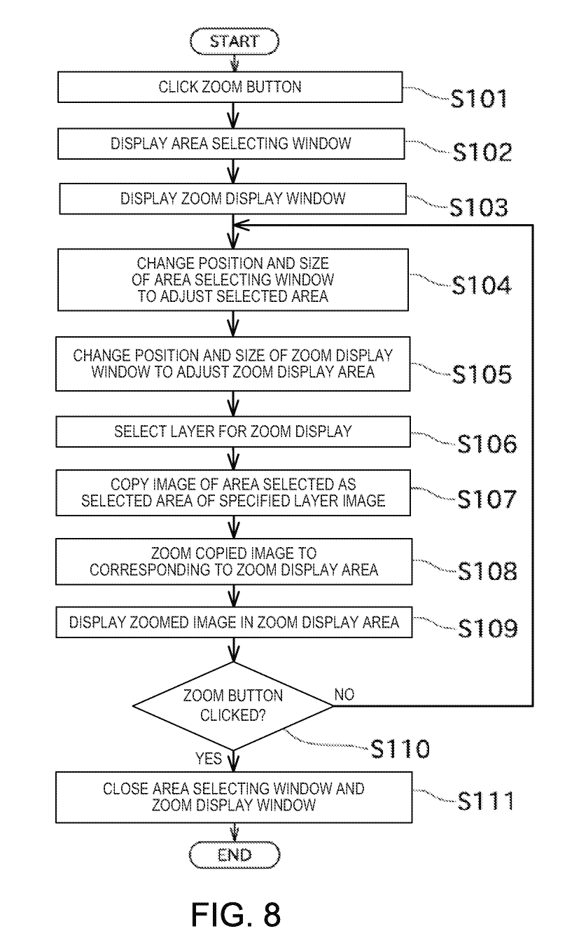

Next, the flowchart in FIG. 8 where the above described image displaying method using the image display device 6 is put together is described.

First, the user activates the image display program to display the image of the chart or the like, through the main display area 30. Subsequently, the user performs a specific operation (Step S101: clicking the ZOOM button 31 in this embodiment) to display the area selecting window 32 (Step S102) and the zoom display window (Step S103).

The user changes the position and size of the area selecting window 32 to adjust the position and size of the selected area 34 (Step S104). Moreover, the user changes the position and size of the zoom display window 33 to adjust the position and size of the zoom display area 35 (Step S105). The user selects one or more layer images which he/she wants to display in the zoom display window as needed, among the chart layer 22, the radar layer 23, and the AIS layer 24 (Step S106).

Next, the image acquiring module 29 copies the image in the area corresponding to the selected area 34 to acquire it from the layer image(s) specified by the user at Step S106 (Step S107). The zoom processing module 37 zooms the image acquired by the image acquiring module 29 to correspond to the zoom display area 35 (Step S108). The zoom display module 28 displays the zoomed image in the zoom display area 35 (Step S109). By such an image display method, an image in an arbitrary area can be displayed at an arbitrary display magnification.

The user can repeat the adjustment of the areas at Steps S104 and S105 until a desired display is obtained. Moreover, the user can delete the area selecting window 32 and the zoom display window 33 (Step S111) by clicking the ZOOM button (Step S110) as needed.

As described above, the image display device 6 of this embodiment includes the main display module 20, the selected area display module 27, the image acquiring module 29, the zoom processing module 37, the zoom display module 28, and the mouse 14. The main display module 20 displays images. The selected area display module 27 displays the area selecting window 32 where at least a part of the selected area in the image displayed on the main display module 20 is specifically displayed. The image acquiring module 29 acquires the image corresponding to the selected area 34. The zoom processing module 37 creates the zoomed image 38 by zooming the image acquired by the image acquiring module 29 to correspond to the zoom display area 35. The zoom display module 28 displays the zoomed image 38 created by the zoom processing module 37, in the zoom display area 35. The mouse 14 can adjust the position and size of the selected area 34, the size of the zoom display area 35, and the like.

In this manner, the part of the image displayed on the main display module 20 can be selected to be zoomed, and then displayed. Thus, the position and size of the selected area 34 or the zoom display area 35 can be adjusted later. Therefore, the zoom magnification and the like can be adjusted finely later. Further, by selecting a part enclosed by the window frame 32a of the area selecting window 32 as the selected area 34, the user can instinctively grasp which area him/herself is selecting. Therefore, the position of the selected area 34 and the zoom magnification and the like can instinctively be adjusted.

As above, the suitable embodiment of the present invention is described. The above configuration may be modified as follows.

In the above embodiment, both the sizes of the selected area 34 and the zoom display area 35 can be adjusted by the user. However, the size of either one of the areas 34 and 35 may be fixed. As long as the user can adjust the size of either one of the selected area 34 and the zoom display area 35, the display magnification of the image to be displayed in the zoom display area 35 can arbitrarily be changed. Moreover, the position of the zoom display area 35 may be fixed.

In the above embodiment, initial positions and sizes of the area selecting window 32 and the zoom display window 33 are determined in advance. However, the position or the size when generating the area selecting window 32 or the zoom display window 33 may be specified by the user.

The area adjusting module for adjusting the positions and sizes of the selected area 34 and the zoom display area 35 is not limited to the mouse 14. For example, the operation may be performed by inputting in value the positions and sizes of the areas through the keyboard 15. Note that, in terms of the user being able to instinctively and easily operate, it is suitable to adjust the positions and sizes of the selected area 34 and the zoom display area 35 by the drag operation of a pointing device, such as the mouse 14.

The pointing device is not limited to the mouse 14 and may be a track ball, etc. Alternatively, the liquid crystal display 10 may be configured as a touch panel so that the selected area 34 or the zoom display area 35 can be adjusted by the user touching the areas.

In the above embodiment, the part enclosed by the window frame 32a of the area selecting window 32 is defined as the selected area 34. However, the method of specifically displaying the selected area 34 is not limited to this. For example, a display method by changing the color of the image in the selected area or a hatching display method may be considered. Importantly, as long the area selected in the image displayed in the main display area 30 is displayed in an easily distinguishable manner, it is not limited to the above embodiment in which the selected area 34 is selected by the window.

In the above embodiment, the selected area 34 and the zoom display area 35 are rectangularly shaped. However, it is not limited to this. For example, the shapes of the selected area and the zoom display area may be circles. Thus, although the setting of the horizontal to vertical ratio is required to be considered in changing the sizes of the areas with the rectangular shapes as the above embodiment, with the circular areas, the only parameter required to be considered in changing the sizes of the areas is a radius (or diameter). Therefore, by shaping the selected area and the zoom display area into circle, the user can adjust the areas more instinctively. Moreover, with the circular areas, even if the chart displayed in the main display area 30 is rotated, the same range can be kept selected on the chart.

In the above embodiment, the image acquired by the image acquiring module 29 is zoomed as it is and displayed. However, an image processor for performing some sort of image processing on the image acquired by the image acquiring module 29 may be provided. The zoom display module 28 displays the image processed by the image processor, in the zoom display area 35. In this manner, by displaying the image that is not processed in the main displayed and displaying the processed image in the zoom display area 35, the both images can be compared to each other on the display, for example. As the image processing performed by the image processor, processing of removing noises contained in the radar image of the radar layer 23 is considered, for example.

The configuration of displaying the superimposed two or more layer images may be omitted.

The image display device of the present invention is not limited to an image display device for ships, and may broadly be applied to image display devices for zooming and displaying images.

In the foregoing specification, specific embodiments of the present invention have been described. However, one of ordinary skill in the technique appreciates that various modifications and changes can be performed without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An image display device, comprising:
a main displaying module for displaying an image;
a selected area displaying module for specifically displaying a selected area that is at least a part of the image displayed by the main displaying module;
an image acquiring module for acquiring an image corresponding to the selected area;
a zoom processing module for creating image data by zooming the image acquired by the image acquiring module to correspond to a predetermined display area;
a zoom displaying module for displaying the image data in the display area; and
an area adjusting module for adjusting at least one of a position and a size of the selected area and a size of the display area.

2. The image display device of claim 1, wherein the area adjusting module is a pointing device to be operated by a user, and adjusts at least one of the position and the size of the selected area through dragging the specifically displayed selected area.

3. The image display device of claim 1, further comprising a deleting module for deleting at least one of the images processed by the selected area displaying module and the zoom displaying module.

4. The image display device of claim 1, wherein the main displaying module selectively displays one or more of a plurality of layer images superimposed on each other, and
wherein the image acquiring module acquires a different layer image from the one or more layer images displayed by the main displaying module.

5. The image display device of claim 4, further comprising a layer storing module for storing the one or more layer images, the one or more layer images being written with at least one of a nautical chart, a radar image, and information on another ship acquired by an automatic identification system (AIS), wherein the image display device is equipped in a ship.

6. The image display device of claim 1, wherein, when the image displayed by the main displaying module is scrolled, rotated, or changed in its scale, the position of the selected area moves to follow the image.

7. The image display device of claim 6, wherein the selected area is moved to follow the image displayed by the main displaying module with reference to central coordinates of the selected area.

8. The image display device of claim 1, wherein the selected area and the display area are shaped in rectangles, and
wherein, when the size of the selected area or the display area is changed, a horizontal-to-vertical ratio of the area is fixed.

9. The image display device of claim 1, wherein the selected area and the display area are shaped in circles.

10. The image display device of claim 1, further comprising an image processing module for performing predetermined image processing on the image acquired by the image acquiring module, wherein the zoom displaying module displays the processed image in the display area.

11. A method of displaying an image, comprising:
displaying the image;
specifically displaying a selected area that is at least a part of the displayed image;
acquiring the image corresponding to the selected area;
creating image data by zooming an image corresponding to the selected area to correspond to a predetermined display area;
displaying the image data in the display area; and
adjusting at least one of a position and a size of the selected area and a size of the display area.
